(19) United States
(12) Patent Application Publication
(10) Pub. No.: US 2003/0007370 A1
(43) Pub. Date: Jan. 9, 2003

(54) System and method for providing electric power

(76) Inventor: Rick Winter, Livermore, CA (US)

Correspondence Address: FACTOR & PARTNERS, LLC, 1327 W. WASHINGTON BLVD., SUITE 5G/H, CHICAGO, IL, 60607, US

(21) Appl. No.: 09/900,761

(22) Filed: Jul. 5, 2001

(51) Int. Cl. H02M 5/45

(52) U.S. Cl. 363/37

(57) ABSTRACT

An electric power providing system comprising a converter control system and a DC power source. The converter control system includes an AC to DC converter electrically associatable with an outside power supply, and, a DC to AC converter electrically associated with the AC to DC converter, and, electrically associatable with a load. The DC power source is electrically associated with each of the AC to DC converter and the DC to AC converter. The DC power source is positioned between the converters. The converter control system includes a member that controls the distribution of power between an outside power supply, the DC power source and a load.

### BACKGROUND OF THE INVENTION

1. Field of the Invention

The invention is directed primarily to the providing of electrical power, and more particularly to a method and apparatus for providing uninterrupted, quality electrical power to a user.

2. Background Art

The use of energy by residential and industrial customers is at an all time high. In particular, industry often works three shifts and the requirement of high reliability electrical power to drive energy consuming lighting and machinery is constant.

One problem with power supply from a provider (i.e. a utility) comprises power interruptions. A power interruption, regardless of duration, can have a detrimental effect on an end user's operation. For example, in many industries a single power outage of only a few milliseconds requires a full shut down of machinery and the resetting of entire assembly lines. This can result in a production standstill that can often last several hours or days. Also, achieving full throughput capacity frequently requires several weeks. Another problem with power supply from a provider is a power disturbance such as a voltage dip or spike. Highly sensitive equipment is often susceptible to damage or disruption due even to minor disturbances in power. Such disturbances likewise can require the resetting of systems and the recalibrating of devices.

Systems that have been developed to date to assist with the foregoing power interruptions and disruptions have only addressed some of these problems. While various systems have been proposed, including motor generators and in line UPS systems, these systems are not suitable for compensating for the wide array of different power interruptions that may be experienced. For example, certain motor generators require a few moments to begin operation, thus, they are not suitable for compensating for commonly occurring momentary or relative brief power interruptions. In-line UPS systems likewise are often not suitable for extended power interruptions.

In addition to quality issues, current users of electrical power on larger scales face electrical energy costs based on several variables. First, the rate the power provider charges for electrical power varies throughout the day. Moreover, additional capacity charges are passed to the user A relative to the peak power provided during each 15- or 30-minute recording interval, over the monthly billing period. Additionally, a user is charged penalties based upon the quality of the loads connected to the electrical power provider (i.e., the operating of equipment which is inductive or which otherwise produces reactive power). Current solutions do not offer a means by which to manage the use of energy by a user, toward the minimization of electrical power costs.

Thus, it is an object of the invention to provide for a system which facilitates continuous electrical power to a user despite service interruptions and disruptions from an outside electrical power provider.

It is another object of the invention to manage the use of energy by a user, to, in turn, minimize the total electrical power costs for the user.

### SUMMARY OF THE INVENTION

The invention comprises an electric power providing/managing system. The system comprises a converter control system and a DC power source. The converter control system includes an AC to DC converter electrically associatable with an outside power supply. Additionally, the DC to AC converter is electrically associated with the AC to DC converter, and, electrically associatable with a load. The DC power source is electrically associated with each of the AC to DC converter and the DC to AC converter. The DC power source is positioned between the converters. The converter control system includes means for controlling the distribution of power between an outside power supply, the DC power source and a load.

In a preferred embodiment, the converter control system includes means associated with DC to AC converter for digitally generating a sinusoidal waveform at the output of the DC to AC converter.

In another preferred embodiment, the distribution controlling means includes means for precluding variations in power provided from the output of the DC to AC converter to a load substantially independently of variations in power provided by an outside power supply.

In another preferred embodiment, the distribution controlling means further includes means for directing power from an outside power supply to one or both of the DC power supply and a load, means for directing power from the DC power supply to a load, and means associated with each of the power directing means for minimizing energy costs related to an outside power supply. In one preferred embodiment, the minimizing means comprises means for precluding the disruption to power supplied by an outside power supply. In another such preferred embodiment, the minimizing means comprises means for reducing the peak demand of power supplied by an outside power supply. In yet another preferred embodiment, the minimizing means comprises means for temporally shifting use of power supplied by an outside power supply.

In a preferred embodiment, the system further comprises means for cooling the converter control system, to in turn, maintain an operating temperature.

In another preferred embodiment, the converter control system includes means for switching between an outside power supply and the power source substantially without affecting the AC power supplied to a load.

Preferably, at least one of the converters comprises solid state switching circuitry. Additionally, at least one of the converters preferably operates in excess of 4 kHz, and the efficiency of the converter control system is in excess of 92%.

In a preferred embodiment, the DC power source comprises a capacitor. In another embodiment, the DC power source comprises a zinc/bromine battery. In yet another preferred embodiment, the DC power source comprises a Li-Ion battery.

The invention further comprises a method for providing power to a load. The method comprises the steps of: (a) providing a AC to DC converter; (b) providing a DC to AC converter; (c) electrically associating the AC to DC converter and the DC to AC converter; (d) electrically associating a power source between the converters; (e) electrically associating the AC to DC converter to an outside power source; (f) electrically associating a load to the DC to AC converter; and (g) controlling the distribution of power between the power source, the outside power source and the load.

In a preferred embodiment, the method further comprises the step of generating an AC waveform from the DC to AC converter.

In another preferred embodiment, the step of controlling the distribution of power further comprises the step of precluding variations in power provided from an output of the DC to AC converter to a load substantially independently of variations in power provided by an outside power supply.

In another preferred embodiment, the step of controlling the distribution of power further comprises the step of directing power from an outside power supply to one or both of the DC power supply and a load. In another preferred embodiment, the step of controlling the distribution of power further comprises the step of directing power from the DC power supply to a load.

Preferably, the step of controlling the distribution of power further comprises the step of minimizing energy costs related to an outside power supply. In one embodiment, the step of minimizing comprises the step of precluding the disruption to power supplied by an outside power supply.

In another such preferred embodiment, the step of minimizing comprises the step of reducing the peak demand of power supplied by an outside power supply. In one such embodiment, the step of reducing comprises the steps of directing power from the DC power supply to a load, reducing the power supplied by an outside power supply in an amount substantially equal to the quantity of power directed from the DC power supply to a load, and continuing the foregoing steps for a predetermined period of time.

In another such preferred embodiment, the step of reducing comprises the steps of directing power from the DC power supply to a load, reducing the power supplied by an outside power supply in an amount substantially equal to the quantity of power directed from the DC power supply to a load, and repeating the foregoing steps for a predetermined portion of each cycle of a predetermined time cycle.

In another preferred embodiment, the step of minimizing comprises the step of temporally shifting use of power supplied by an outside power supply.

In yet another preferred embodiment, the step of controlling the distribution of power comprises the steps of generating an AC waveform for a load, supplying the load with power from at least one of the power supply and the outside power source, and switching the supply of power to the other of the power supply and the outside power source without affecting the generated AC waveform.

In a preferred embodiment, the method further includes the steps of gathering at least one data parameter pertaining to the system, transmitting the at least one data parameter, and receiving the at least one transmitted data parameter at a remote location.

### BRIEF DESCRIPTION OF THE DRAWINGS

FIG. 1 of the drawings is a schematic view of the system of the present invention;

FIG. 2 of the drawings is a sample graph of power usage over a 24-hour period;

FIG. 3 of the drawings is a sample graph of power usage over a 24-hour period wherein power is supplied in part by the DC power source;

FIG. 4 of the drawings is a sample graph of power usage over a 3-hour period; and

FIG. 5 of the drawings is a sample graph of power usage over a 3-hour period wherein power is supplied in part by the DC power source for a predetermined period of time each hour.

### BEST MODE FOR PRACTICING THE INVENTION

While this invention is susceptible of embodiment in many different forms, there is shown in the drawings and will be described in detail, one specific embodiment with the understanding that the present disclosure is to be considered as an exemplification of the principles of the invention and is not intended to limit the invention to the embodiment illustrated.

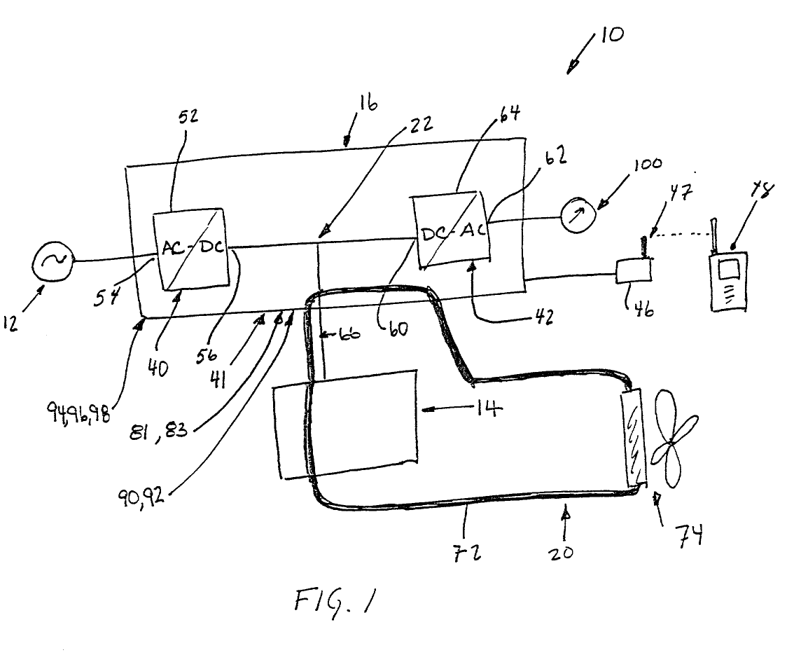

Electric power providing system 10 is shown in FIG. 1 as comprising DC power supply 14 converter control system 16, cooling system 20 and means 21 for reporting the status of the system. As will be explained in detail below, converter control system 16 controls the conversion of outside power supply 12, incorporation of DC power supply and the reconversion of the combined power supplies from DC to AC to power load 100.

Specifically, converter control system 16 includes AC to DC converter 40, junction 22, DC to AC converter 42 and controller 41. The AC to DC converter 40 comprises a solid state switching circuitry 52, input connection 54 and output 56. Solid state switching circuitry generally operates in the range of 4 kHz to 30 kHz, and preferably above 12 kHz. With such frequency of operation, switching circuitry 52 has an efficiency of about 97%. Of course, the system is not limited to any particular efficiency, but, the higher efficiency, the higher the efficiency of the overall system. It will be understood that the power that is not converted from AC to DC is dissipated as heat.

Input connection 54 is shown in FIG. 1 as being electrically coupled to outside power supply 12. The outside power supply generally comprises a high voltage power source (i.e. 480V 3-phase supply), commonly known as grid power. Output connection 56 is shown in FIG. 1 as being electrically coupled to solid state switching circuitry. Output connection 56 is configured to provide DC power as converted by the solid state switching circuitry.

Junction 22 includes a connection that places DC output connection 56 in electrical association with DC power supply 14. DC to AC converter 42 comprises input 60, output 62 and solid state switching circuitry 64. Input 60 is coupled to junction 22 and is capable of receiving DC power. Solid state switching circuitry 64 operates in a range between 9 kHz and 30 kHz, and preferably above 12 kHz, and has an efficiency of about 97%. Of course, the solid state switching circuitry 64 is not limited to those operational ranges and efficiencies. Output 62 is then associated with a power consumption device such as a motor, a light emitter, etc.

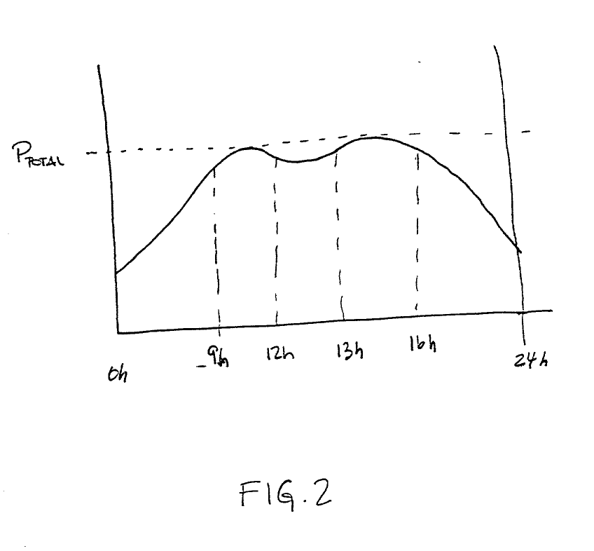

Controller 41 is shown in FIG. 2 as comprising means 81 for controlling the conversion of DC into AC by DC to AC converter 42, and means 83 for controlling the distribution of power among outside power supply 12, power source 14 and any loads such as load 100 attached to DC to AC converter output 62.

In particular, conversion controlling means 81 comprises suitable microprocessor circuitry and software so as to provide means 90 for generating an AC wave form, and means 92 for precluding the variation of quality of the wave form. While not limited to any particular form, the generating means will generally direct the DC to AC converter to produce a sine wave of 50 or 60 Hz (depending on the installation). The quality variation precluding means insures that regardless of which power source provides the input DC power, the generated wave form remains continuous and free of intermittent and incessant power quality variations. The operation of such means is disclosed below in detail.

Power distribution controlling means 83 includes microprocessor circuitry and software which provide means 94 for directing power from outside power supply to one or both of power supply 14 and DC to AC converter 42 (and in turn load 100), means 96 for directing power from DC power supply 14 to DC to AC converter 42 and means 98 for minimizing cost of power from outside power supply 12.

Outside power supply directing means 94 is capable of directing power provided by outside power supply 12 to power supply 14 (i.e. charging situation), to DC to AC converter 42, or both. DC power supply directing means is capable of directing power provided by DC power supply to DC to AC converter.

Means 98 for minimizing costs of power provided from outside power supply 12 comprises the controlling of outside power supply directing means 94 and power supply directing means 96 to, in turn, control the source of power at any given time that is provided to load 100. As will be explained below in detail, the cost minimizing means can temporarily adjust the delivery of power from outside power source 12, can minimize peak usage of power from power source 12 and can preclude penalties based upon inefficient and disruptive power use.

DC power supply 14 may comprise any number of storage devices capable of storing an electrical charge. In one embodiment, the power supply may comprise one or more zinc/bromine batteries. Such batteries have been shown to be durable for extended periods of time. Indeed, they are capable of repeated charge and discharge cycles over a number of years. In other embodiments, the storage supply may comprise one or more capacitors, such as those available from Powercell under the trademark Ultracapacitor. In yet other embodiments, the storage supply may comprise one or more lead acid batteries, NiMH, NiCAD, Li-ion batteries. Each type of storage supply has unique advantages for particular applications. Additionally, the storage capability, capacity and other factors will vary for each type of storage device. It will be understood that the invention is not limited to the use of any particular type of storage supply device. Regardless of the type of storage supply utilized, the power supply includes junction connection 66, which is capable of electrically associating storage supply 14 to junction 22.

As shown in FIG. 1, in certain embodiments, cooling system 20 may be employed. Cooling system 20 provides cooling to converter control system 16 and to power supply 14. Specifically, cooling system 20 includes conduit 72 and heat exchanger 74. Conduit 72 is routed through one or both of converter control system 16 and power supply 14 to draw heat therefrom. Heat exchanger 74 is utilized so as to cool the fluid after it has drawn heat from the converter control system and the power supply. It will be understood that in certain embodiments, the use of a cooling system may not be necessary.

Reporting means 21 comprises data collector 46, data transmitter 47 and remote data receiver 48. Data collector 46 may comprise a computer which collects data from various sensors and from controller 41 (i.e. battery voltage, power usage, power quality, battery condition, etc.). Data transmitter 47 is associated with data collection and serves to transmit the data to remote receiver 48. The data transmitter may comprise a modem, wherein receiver comprises a modem associated with a remote computers. In other embodiments, the transmitter may be configured to transmit data wirelessly directly to the receiver or to a satellite for retransmission to a receiver located in a remote location. In yet other embodiments, the transmitter may be associated with the World Wide Web wherein the data is transmitted via the web to a remote server. In such an embodiment, a user can have access to the data from any machine which is connected to the World Wide Web.

In operation, the user is first provided with DC power supply 14 and converter control system 16. Next, the user electrically couples outside power supply 12 to input 52 of AC to DC converter 40. Once coupled, the system is ready for operation. Specifically, the system is ready to accept load 100 that can be attached to output 62. Additionally, if power supply 14 is in a uncharged or partially charged state, outside power supply directing means 94 can direct power to DC power supply 14 so that DC power supply 14 can be charged by way of the power from outside power supply 12. Specifically, once connected, AC to DC converter 40 accepts AC power and converts the power (through the use of the solid state switching circuitry) to DC. Once switched to DC, the DC power is available at junction 22 and controlled by distribution controlling means 83.

From time to time, it may be desirous to charge power supply 14. In such a condition, the distribution controlling means 83 directs DC power from junction 22 to power supply 14 so that power supply 14 can be charged. Indeed, power distribution controlling means 83 generally controls the charging parameters for power supply 14 (i.e. strength of charge, time to charge, rate of charge, etc).

While the power is generally supplied by outside power supply 12, power supply 14 may be utilized to supply power. Specifically, in certain circumstances, power from the outside power supply may become disrupted. For example, it is common for outside power supply 12 to include a multitude of intermittent power quality variations as well as incessant power quality variations. Intermittent power quality variations include voltage spikes, noise, sags and swells. Incessant power quality variations include notches, voltage distortion, undervoltage, overvoltage and frequency variation. Since the outside power supply is converted into DC and filtered, and subsequently converted back to an AC wave form by DC to AC converter 42 under strict control by generating means 90, a substantially uniform sinusoidal wave (or other wave form) substantially free of power quality variations is created and, in turn, power provided to any loads coupled to output voltage 18 are clean. As a result, power quality variations are substantially eliminated.

From time to time, power supplied from outside power supply 12 may become interrupted. These interruptions can be momentary, or on the order of minutes, hours or even days. Depending on the sensitivity of equipment used at any particular location, even a momentary power interruption can have disastrous effects. Since DC power source 14 is electrically coupled to junction 22, and, in turn, on line, power from DC power source 14 is immediately available in the event of an interruption. In such a situation, power distribution means 83 and, in particular, directing means 96 immediately begins to supply power to DC to AC converter 42 from power supply 14. Generating means 90 continues to control uninterrupted power, however, such power is directed from power source 14.

Based on the different charges for power by outside power provider, the cost minimizing means can minimize the power costs to the user. For example, a business is generally charged by the power provider in several different ways. First, the provider charges for the quantity of electricity utilized, wherein the cost per unit of power varies throughout the day, (i.e., more expensive in the daylight hours and less expensive during the overnight hours). Next, the provider likewise charges for the peak quantity of electricity utilized by the power provider. Lastly, the provider charges a penalty for use of power by inefficient loads, such as inductive loads, (i.e. motors), since these reactive loads require greater transmission and distribution capacity by the provider. The power providing system of the present invention can serve to minimize such charges.

With respect to the first type of charge, the user can program minimizing means 90 and, in particular, the use of power distribution controlling means 82 of converter control system 16 to provide power from power source 14 when the cost per unit of power from outside power supply 12 is highest. At some point, converter control system 16 will direct the supply of power to DC power source 14 from power from outside power supply 12, such as when the cost per unit of power from outside power supply 12 is obtainable at a lower cost (such as typically overnight hours). Thus, while the quantity of power received from outside power supply 12 remains substantially unchanged, the overall cost of the power from outside power supply 12 is reduced since the draw of such power has been temporarily shifted.

Peak usage charges can likewise be reduced through programming of the minimizing means use of the present system. For example, a typical usage graph is shown in FIG. 2, wherein peak usage occurs during the time period of 9am to 12pm (9 h-12 h) and 1pm to 4pm (13 h-16 h). Of course, depending on the particular installation the usage graph may or may not correspond to that which is shown in FIG. 2, and it will be understood that the graph is only used for purposes of example. In this example, the peak usage as seen by the power company corresponds to Pₜₒₜₐₗ, thus, the user is charged for a peak demand of Pₜₒₜₐₗ.

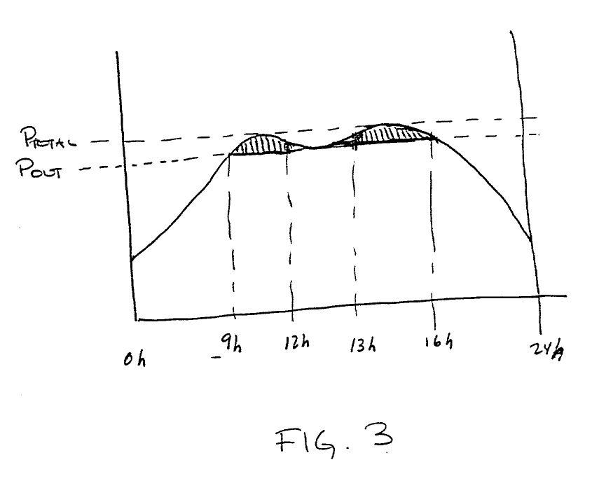

By configuring minimizing means, and, in turn, power distributing controlling means to draw power from power source 14 at times of peak usage, the peak quantity of power from outside power supply 12 can be reduced. For example, as shown in FIG. 3, power drawn from outside power supply 12 can be limited to Pₒᵤₜ which is less than Pₜₒₜₐₗ. The remaining power that is required, namely, the difference between Pₜₒₜₐₗ and Pₒᵤₜ can be provided by power supply 14. Power supply 14 can then be recharged when usage is low and/or when the cost of power is lower. The quantity of power that is available from power supply 14 and the duration that such power can be supplied is a function of the type of cells, the capacity of the cells contained therein.

In another embodiment, the minimizing means can be used to lower the peak quantity of power that is provided in a different manner. Specifically, most power providers determine peak usage by looking at total usage over a half-hour or one hour period and determining a “peak” usage by way of formula. Thus, by lowering the quantity of power utilized over an hour period, a lower “peak” will be calculated by the power provider.

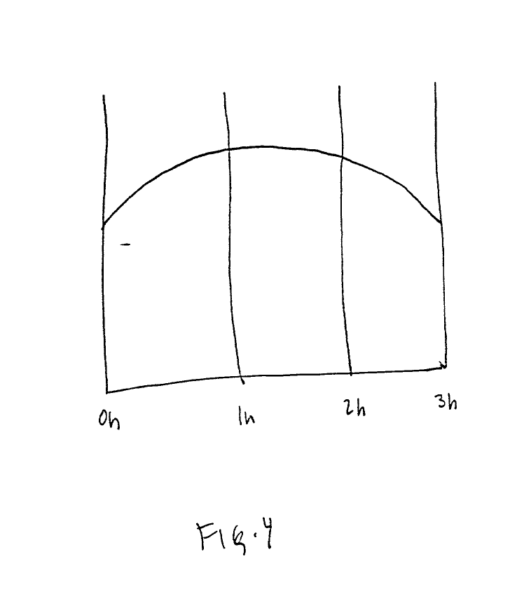

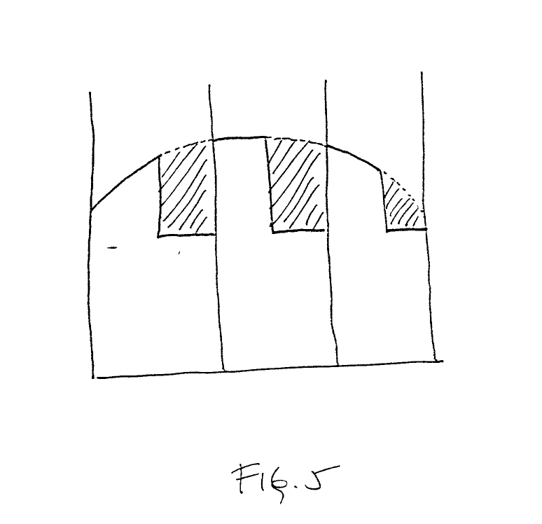

For example, controlling power distribution controlling means 83 by minimizing means power supply 14 can be activated to provide a portion of the power for a quantity of time each hour, the total power drawn from outside power supply is reduced. For comparison purposes, FIG. 4 shows a general power usage graph over a three-hour period, wherein all of the power requirements are provided by outside power supply 12. FIG. 5 shows the same power usage graph wherein, the shaded portion represents power drawn from power supply 14 that operates for a predetermined quantity of time each hour. The peak usage shown in FIG. 4 and FIG. 5 are identical, yet, since the total power drawn from outside power supply for the hour is reduced (i.e. the non-shaded area below the graph in FIG. 5 is greater than that of FIG. 6), the calculated “peak” usage is likewise reduced with use of power source 14. In turn, a lower peak charge is assessed against the user. It will be understood that power source 14 can be recharged during off peak periods of time.

In another embodiment, the minimizing means can be used to lower the charges for both the peak rate of power consumption and the total power consumed by enabling the customer to buy power from the power provider at the less expensive interruptible rate, while maintaining uninterruptible power availability to the customer. In the event of an interruption by the power provider, power supply 14 provides power to the customer for a predetermined period of time. Typically, power providers will interrupt power to a customer for only 1 hour at a time and then roll the interruption to the next customer. This means of power cost reduction provides for highly accurate projections of cost savings to the customer, while maximizing the lifecycle and efficiency of power source 14.

Lastly, the minimizer means can be used to minimize charges based upon the inefficient use of power. For example, as inductive loads, motors increase the transmission and distribution requirements for power from a power supply as a result of reactive power issues. Since the power supplier must compensate for the increase, the supplier generally assesses a penalty to those users who utilize loads (i.e. motors, a/c units, etc.) that cause such disruptions. Through use of the minimizing means together with generating means 90, any efficiency reductions to the outside power provider based upon inefficient use of power can be minimized. Specifically, since converter control system converts the power from outside power supply to DC then reconverts the DC into AC, the inductive loads and other inefficient loads only affect the AC power that is provided from output 62 of converter control system 16. That is, such inefficiencies are not propagated throughout converter control system 16 to outside power supply 12. In fact, outside power supply 12 is substantially free of any power factor induced inefficiencies from the user regardless of what type of loads are attached to output 62 of DC to AC converter 42. Without disruptions to outside power supply 12, the user is free of power factor penalties, even where the loads utilized are known to be significantly inductive.

In sum, the foregoing system can be utilized to provide power to a load so that the load receives quality power that is substantially uninterrupted and provided at a lower overall cost.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. An electric power providing/managing system comprising:
a converter control system having:
an AC to DC converter electrically associatable with an outside power supply; and
a DC to AC converter electrically associated with the AC to DC converter, and, electrically associatable with a load;
a DC power source electrically associated with each of the AC to DC converter and the DC to AC converter, the DC power source being positioned between the converters;
wherein the converter control system includes means for controlling the distribution of power between an outside power supply, the DC power source and a load.

2. The system of claim 1 wherein the converter control system includes means associated with DC to AC converter for generating a sinusoidal waveform at the output of the DC to AC converter

3. The system of claim 1 wherein the distribution controlling means includes means for precluding variations in power provided from the output of the DC to AC converter to a load substantially independently of variations in power provided by an outside power supply.

4. The system of claim 1 wherein the distribution controlling means further includes:
means for directing power from an outside power supply to one or both of the DC power supply and a load;
means for directing power from the DC power supply to a load; and
means associated with each of the power directing means for minimizing energy costs related to an outside power supply.

5. The system of claim 4 wherein the minimizing means comprises means for precluding the disruption to power supplied by an outside power supply.

6. The system of claim 4 wherein the minimizing means comprises means for reducing the peak demand of power supplied by an outside power supply.

7. The system of claim 4 wherein the minimizing means comprises means for temporarily shifting use of power supplied by an outside power supply.

8. The system of claim 1 further comprising means for cooling the converter control system, to in turn, maintain an operating temperature.

9. The system of claim 1 wherein the converter control system includes means for switching between an outside power supply and the power source substantially without affecting the AC power supplied to a load.

10. The system of claim 1 wherein at least one of the converters comprises solid state switching circuitry.

11. The system of claim 1 wherein at least one of the converters operates in excess of 4 kHz.

12. The system of claim 1 wherein the efficiency of the converter control system is in excess of 92%.

13. The system of claim 1 wherein the DC power source comprises a capacitor.

14. The system of claim 1 wherein the DC power source comprises a zinc/bromine battery.

15. The system of claim 1 wherein the DC power source comprises a Li-Ion battery.

16. A method for providing power to a load, the method comprising the steps of:
providing a AC to DC converter;
providing a DC to AC converter;
electrically associating the AC to DC converter and the DC to AC converter;
electrically associating a power source between the converters;
electrically associating the AC to DC converter to an outside power source;
electrically associating a load to the DC to AC converter; and
controlling the distribution of power between the power source, the outside power source and the load.

17. The method according to claim 16 further comprising the step of generating an AC waveform from the DC to AC converter.

18. The method according to claim 16 wherein the step of controlling the distribution of power further comprises the step of precluding variations in power provided from the output of the DC to AC converter to a load substantially independently of variations in power provided by an outside power supply.

19. The method of claim 16 wherein the step of controlling the distribution of power further comprises the step of:
directing power from an outside power supply to one or both of the DC power supply and a load.

20. The method of claim 16 wherein the step of controlling the distribution of power further comprises the step of:
directing power from the DC power supply to a load.

21. The method of claim 16 wherein the step of controlling the distribution of power further comprises the step of:
minimizing energy costs related to an outside power supply.

22. The method of claim 21 wherein the step of minimizing comprises the step of:
precluding the disruption to power supplied by an outside power supply.

23. The method of claim 21 wherein the step of minimizing comprises the step of:
reducing the peak demand of power supplied by an outside power supply.

24. The method of claim 23 wherein the step of reducing comprises the steps of:
directing power from the DC power supply to a load; and
reducing the power supplied by an outside power supply in an amount substantially equal to the quantity of power directed from the DC power supply to a load;
continuing the foregoing steps for a predetermined period of time.

25. The method of claim 23 wherein the step of reducing comprises the steps of:
directing power from the DC power supply to a load; and
reducing the power supplied by an outside power supply in an amount substantially equal to the quantity of power directed from the DC power supply to a load;
repeating the foregoing steps for a predetermined portion of a predetermined time cycle.

26. The method of claim 21 wherein the step of minimizing comprises the step of:
temporarily shifting use of power supplied by an outside power supply.

27. The method of claim 21 wherein the step of controlling the distribution of power comprises the steps of:
generating an AC waveform for a load;
supplying the load with power from at least one of the power supply and the outside power source; and
switching the supply of power to the other of the power supply and the outside power source without affecting the generated AC waveform.

28. The method of claim 16 further comprising the steps of:
gathering at least one data parameter pertaining to the system;
transmitting the at least one data parameter; and
receiving the at least one transmitted data parameter at a remote location.
